(19) United States
(12) Patent Application Publication
(10) Pub. No.: US 2005/0178434 A1
(43) Pub. Date: Aug. 18, 2005

(54) Self-draining vacuum breaker

(76) Inventor: Yung-Fang Yang, Changhua County (TW)

Correspondence Address: BACON & THOMAS, PLLC, 625 SLATERS LANE, FOURTH FLOOR, ALEXANDRIA, VA, 22314, US

(21) Appl. No.: 10/944,841

(22) Filed: Sep. 21, 2004

(30) Foreign Application Priority Data
Feb. 12, 2004 (TW) 93202018

(51) Int. Cl. F16K 24/02

(52) U.S. Cl. 137/218

(57) ABSTRACT

A self-draining vacuum breaker includes a first valve having an inlet at its one end for connecting an outfall, a second valve having a coupling portion at its one end connected with the other end of the first valve, an outlet at its the other end for connecting a hose, and an annular fringe formed at an inner periphery thereof, a movable stopper having a stopping member and a plurality of claw hooks, which extends downwards from the stopping member and movably contacts against the inner periphery of the outlet of the second valve and each has a barb-like hook portion, and a spring having two ends respectively engaging the barb-like hook portions and lying against the annular fringe.

### BACKGROUND OF THE INVENTION

1. Field of the Invention

The present invention relates generally to automatic drainage system, and more particularly to a self-draining vacuum breaker, which internal component parts are modularized to enhance assembly efficiency and to reduce the trouble of scattering of the component parts during assembly and disassembly.

2. Description of the Related Art

In a common automatic sprinkler system, when a faucet is switched on, the water flows out of the faucet, through a hose, and then sprays out of a distal end of the hose; when the faucet is switched off, a vacuum is generated in the hose to prevent the water remaining in the hose from drain. Hence, if the winter comes and the temperature drops to the freezing point, the remaining water will freeze to become ice and its expansion may rupture the hose. To solve this problem, a conventional self-draining vacuum breaker 1, as shown in FIG. 1, was developed, certainly eliminating the vacuum in the hose. However, in the conventional self-draining vacuum breaker 1, there is only a spring 6 contacting against a claw hook 4 of a movable stopper 5 and there is none of any connection between the movable stopper 5 and the spring 6, such that while assembling the self-draining vacuum breaker 1, the movable stopper 5 and the spring 6 have to be installed separately, thereby being inconvenient for the user. Furthermore, while disassembling the self-draining vacuum breaker 1, the spring 6 tends to bounce away and even get lost due to none of connection with the movable stopper 5 or other component parts. In addition, the self-draining vacuum breaker 1 needs complex steps to complete the assembly and it is difficult for the user to conveniently pick up the separate component parts during the assembly.

### SUMMARY OF THE INVENTION

The primary objective of the present invention is to provide a self-draining vacuum breaker, which component parts can be promptly picked up and further fastened and assembled conveniently.

The secondary objective of the present invention is to provide a self-draining vacuum breaker, which component parts are not subject to bouncing scatteration and getting lost.

The foregoing objectives of the present invention are attained by the self-draining vacuum breaker, which is connected between an outfall of a faucet and a hose. The self-draining vacuum breaker is comprised of a tubular first valve, an internally-stepped tubular second valve, a circular diaphragm, a movable stopper, and a spring. The first valve includes an inlet formed at an end thereof for connecting the outfall of the faucet. The second valve includes a coupling portion formed at an end thereof and having a larger diameter than and threadedly connected with the other end of the first valve, and an outlet formed at the other end thereof and connected with the hose and having an annular fringe formed at an inner periphery thereof. The circular diaphragm is coaxially mounted in the coupling portion of the second valve, having at least one through hole running therethrough. The movable stopper is mounted below the circular diaphragm, having a stopping member for covering the through hole of the diaphragm, and a plurality of claw hooks extending downwards from the stopping member and movably contacting against the inner periphery of the outlet of the second valve and each having a barb-like hook portion. The spring is jammed with the barb-like hook portions of the claw hooks at an end thereof, lying against the annular fringe of the outlet at the other end thereof.

### BRIEF DESCRIPTION OF THE DRAWINGS

FIG. 1 is an exploded view of a first preferred embodiment of the present invention.

FIG. 2 is an exploded view of the first preferred embodiment of the present invention.

FIG. 3 is an elevational view of the movable stopper and the spring according to the first preferred embodiment of the present invention.

FIG. 4 is a sectional view of the first preferred embodiment of the present invention.

FIG. 5 is an elevational view of the movable stopper according to a second preferred embodiment of the present invention.

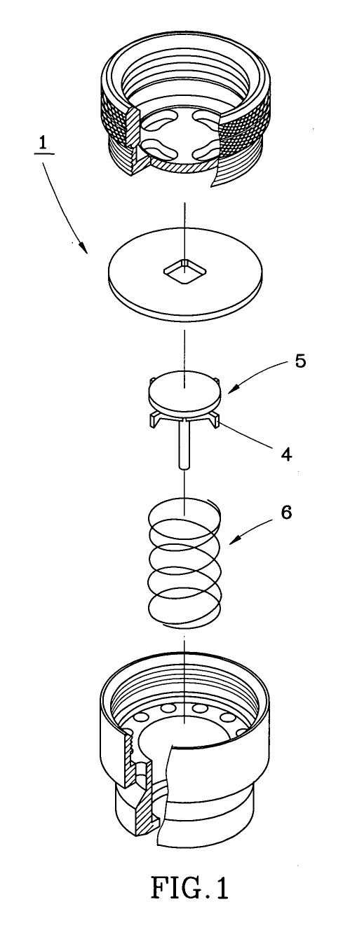

### DETAILED DESCRIPTION OF PREFERRED EMBODIMENTS

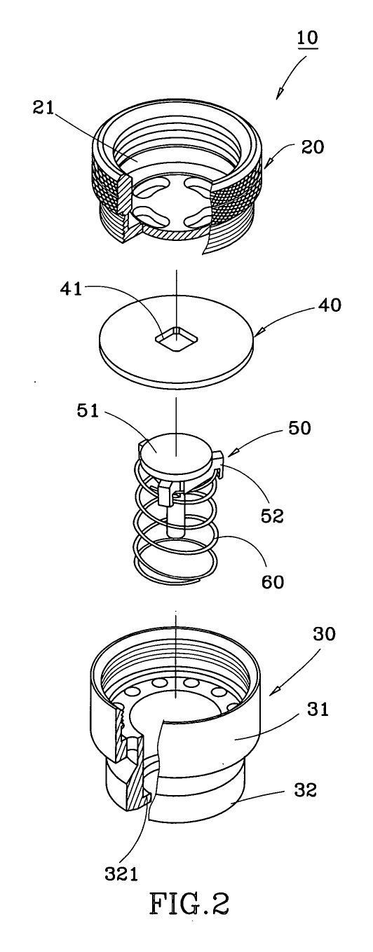

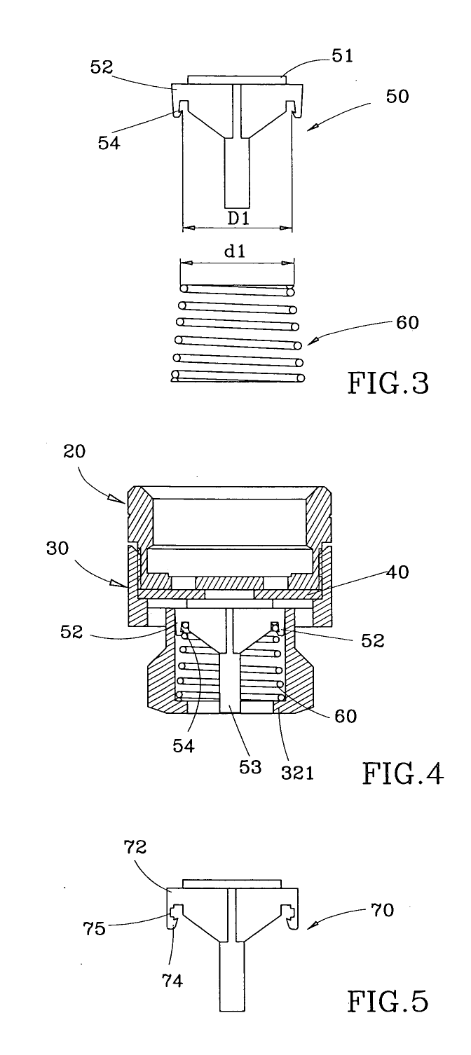

Referring to FIGS. 2-3, a self-draining vacuum breaker 10 constructed according to a first preferred embodiment of the present invention is comprised of a tubular first valve 20, an internally-stepped tubular second valve 30, a circular diaphragm 40, a movable stopper 50, and a spring 60.

The first valve 20 includes an inlet 21 formed at an end thereof for connecting an outfall of a faucet (not shown).

The second valve 30 is threadedly connected with the first valve 20, including a coupling portion 31 formed at an end thereof and having a larger diameter than that of the other end of the first valve 20 and connected with the other end of the first valve 20, and an outlet 32 formed at the other end thereof for connecting a hose (not shown). The outlet 32 has an annular fringe 321 formed radially at a bottom end thereof.

The circular diaphragm 40 is coaxially mounted in the coupling portion 31 and abutting between the first and second valves 20 and 30, including at least one through hole 41 running through a center thereof.

The movable stopper 50 is mounted under the diaphragm 40, having a stopping member 51 for covering the through hole 41 of the diaphragm 40, and a plurality of claw hooks 52 extending downwards from the stopping member 51 and movably contacting against an inner periphery of the outlet 32. Each of the claw hooks 52 has a barb-like hook portion 54 extending inwards from a distal end thereof. An imaginary circle defined by distal ends of the hook portions 54 has a diameter D1.

The spring 60 is a compression spring, which outer diameter d1 is larger than the diameter D1, having an end lying against the annular fringe 321 of the outlet 32, and the other end jammed with the hook portions 54 of the claw hooks 52, as shown in FIG. 4, such that the spring 60 and the movable stopper 50 are combined together in one piece.

The outer diameter d1 of the spring 60 is larger than the diameter D1 of the hook portions 54, the spring 60 tends to elastic deformation by a force, and the hook portions 54 tend to elastic outward expansion by oppression, such that while the spring 60 is put upwards into a space defined by the hook portions 54 of the claw hooks 52 and the stopping member 51, its one end can jostle through the hook portions 54 and then slide into the space. Meanwhile, the spring 60 has the one end secured in the space among the hook portions 54 and the stopping member 51 to avoid bouncing scatteration during the assembly and disassembly.

FIG. 5 shows a second preferred embodiment of the present invention. In this embodiment, each of the claw hooks 72 of the movable stopper 70 further includes a recession 75 formed at an inner side of the hook portion 74 for engaging one end of the spring 60 while the spring 60 jostles through the hook portions 74 to further enable the movable stopper 70 to be combined with the spring 60 much tight and to greatly prevent the spring 60 from bouncing scatteration during the assembly and disassembly.

1. A self-draining vacuum breaker comprising:
a first valve having an end for connecting an outfall of a faucet;
a second valve having a coupling portion at its one end connected with the other end of said first valve, an outlet for connecting a hose, and an annular fringe formed at an inner periphery of said outlet;
a circular diaphragm coaxially mounted in said coupling portion of said second valve and having a through hole at its center;
a movable stopper mounted below said circular diaphragm, said movable stopper having a stopping member for covering said through hole of said diaphragm, and a plurality of claw hooks extending downwards from said stopping member, each of said claw hooks having its external end contacting against the inner periphery of said outlet; and
a spring having two ends contacting respectively against said claw hooks of said movable stopper and said annular fringe of said outlet;
wherein said movable stopper further comprises a barb-like hook portion extending from a distal end of each claw hook for engaging one end of said spring, a diameter of an imaginary circle defined by distal ends of said hook portions being smaller than an outer diameter of said spring, said spring jostling through said hook portions to engage said hook portions.

2. The self-draining vacuum breaker as defined in claim 1, wherein each of said hook portions of said claw hooks comprises a recession formed at an inner side thereof for engaging said spring much tight.
